(19) United States
(12) Patent Application Publication
(10) Pub. No.: US 2026/0229397 A1
(43) Pub. Date: Aug. 6, 2026

(54) COIL ELECTRONIC COMPONENT

(71) Applicant: SAMSUNG ELECTRO-MECHANICS CO., LTD., Suwon-si (KR)

(72) Inventors: Soonkwang Kwon, Suwon-si (KR); Dong Jin Lee, Suwon-si (KR); Donghwan Lee, Suwon-si (KR); Tae Hyun Kim, Suwon-si (KR); Kangryong Choi, Suwon-si (KR)

(73) Assignee: SAMSUNG ELECTRO-MECHANICS CO., LTD., Suwon-si (KR)

(21) Appl. No.: 19/253,219

(22) Filed: Jun. 27, 2025

(30) Foreign Application Priority Data
Feb. 5, 2025 (KR) 10-2025-0014526
Mar. 4, 2025 (KR) 10-2025-0027517

(51) Int. Cl. H01F 27/28; H01F 27/29

(52) U.S. Cl. CPC H01F 27/2828; H01F 27/292

(57) ABSTRACT

A coil electronic component includes a magnetic body including a magnetic material, a coil embedded in the magnetic body and including at least one turn of a conductive wire, a lead-out terminal connected to the coil, and a frame including a recess in which the lead-out terminal is received, wherein a conductive layer is disposed between the lead-out terminal and the recess.

### CROSS-REFERENCE TO RELATED APPLICATIONS

This application claims priority to and the benefit of Korean Patent Application No. 10-2025-0014526 filed on Feb. 5, 2025 and 10-2025-0027517 filed on Mar. 4, 2025, in the Korean Intellectual Property Office, the entire contents of which are incorporated herein by reference.

### BACKGROUND

### 1. Technical Field

The present disclosure relates to a coil electronic component.

As functions of mobile devices have diversified recently, power consumption has increased, and to increase a battery usage time in the mobile devices, coil electronic components with low loss and high efficiency are being used around power semiconductors (power management integrated circuits (PMIC)).

The coil electronic component may include a coil embedded in a magnetic body and a frame connected to the coil and functioning as an electrode, where the connection between the coil and the frame may be damaged by external vibrations. Meanwhile, if the frame is thick, the size of the magnetic body is relatively reduced, which may degrade the electromagnetic characteristics of the coil electronic component. In addition, if the coil and the frame are connected to each other by welding, the cross-sectional area of the welded joint is smaller than the cross-sectional area of the conductive wire of the coil, which may increase the direct current resistance (Rdc).

### SUMMARY

An aspect of the embodiment attempts to provide a coil electronic component that can maintain strong connection between the coil and the frame, can reduce direct current resistance, and can improve electromagnetic properties.

However, the problem to be solved by the present embodiments is not limited to the above-described problems, and can be variously extended within the scope of the technical spirit included in the present disclosure.

A coil electronic component according to an embodiment may include a magnetic body including a magnetic material, a coil embedded in the magnetic body and including at least one turn of a conductive wire, a lead-out terminal connected to the coil, a frame including a recess in which the lead-out terminal is received, and a conductive layer disposed between the lead-out terminal and the recess.

The recess may include a first surface, a first interior surface, and a second interior surface, and the lead-out terminal may contact the first interior surface and the second interior surface.

The conductive layer may be disposed between the lead-out terminal and the first surface.

The recess may further include a third interior surface connecting the first interior surface and the second interior surface, and the lead-out terminal may contact the third interior surface.

The recess may include a first surface, a first interior surface, and a second interior surface, and the conductive layer may be disposed between the lead-out terminal and the first surface, between the lead-out terminal and the first interior surface, and between the lead-out terminal and the second interior surface.

The recess may further include a third interior surface connecting the first interior surface and the second interior surface, and the lead-out terminal may contact the third interior surface.

The frame may further include a frame body and an extension protruding from the frame body.

A maximum width of the recess may be smaller than a width of the frame body.

A thickness of the frame body may be smaller than a thickness of the extension.

A maximum width of the recess may be the same as a width of the frame body.

The frame body may be disposed outside the magnetic body.

The extension may include a first portion disposed outside the magnetic body and a second portion connected to the first extension and disposed inside the magnetic body.

The second portion may have a bent shape relative to the first portion.

The frame body may include a first frame body including the recess and a second frame body connected to the first frame body.

The second frame body may have a bent shape relative to the first frame body.

The first frame body may be disposed on an end surface in a length direction of the magnetic body, and the second frame body may be disposed on a first surface of the magnetic body.

The first frame body may include a first main surface proximate an end surface in a length direction of the magnetic body and a second main surface opposite the first main surface, and the recess may be a depression in a portion of the second main surface.

The first frame body may include a first main surface proximate an end surface in a length direction of the magnetic body and a second main surface opposite the first main surface, and the recess may be a depression in a portion of the first main surface.

The lead-out terminal may have a length greater than or equal to 50% or less than or equal to 70% of a length of the frame.

A thickness of the lead-out terminal may be smaller than a depth of the recess.

The lead-out terminal may include copper (Cu).

The frame may include (i) copper (Cu), (ii) tin (Sn) or an alloy of any of (i)-(ii).

The conductive layer may include (i) silver (Ag), (ii) copper (Cu), (iii) annealed copper, (iv) gold (Au), (v) aluminum (Al), (vi) calcium (Ca), (vii) tungsten (W), (viii) zinc (Zn), (ix) nickel (Ni), (x) lithium (Li), (xi) iron (Fe), (xii) platinum (Pt), (xiii) tin (Sn), or an alloy of any of (i)-(xiii).

The conductive layer may include an intermetallic compound.

The intermetallic compound may include Cu₆Sn₅ and/or Cu₃Sn.

The conductive layer may include metal nanoparticles.

A coil electronic component according to an embodiment may include a magnetic body including a magnetic material, a coil embedded in the magnetic body and including at least one turn of a conductive wire, a lead-out terminal connected to the coil, a frame including a recess, wherein the lead-out terminal is disposed in the recess, and wherein the recess faces outward from the magnetic body.

A conductive layer may be disposed between the lead-out terminal and the frame, and a thickness of the lead-out terminal may be smaller than a depth of the recess.

The conductive layer may include nanoparticles that include silver (Ag).

The conductive layer may include an intermetallic compound.

A coil electronic component according to an embodiment may include a magnetic body including a magnetic material, a coil embedded in the magnetic body and including at least one turn of a conductive wire, a lead-out terminal connected to the coil, a frame including a recess, the recess including a first end through which the lead-out terminal is received, wherein the first end of the recess and a second end of the recess oppose each other in a thickness direction of the coil electronic component.

conductive layer may be disposed between the lead-out terminal and the frame, and a thickness of the lead-out terminal may be smaller than a depth of the recess.

The conductive layer may include nanoparticles that include silver (Ag).

The conductive layer may include an intermetallic compound.

According to the embodiment, it may be possible to provide a coil electronic component that can strongly maintain the connection between the coil and the frame, can reduce direct current resistance, and can improve the electromagnetic properties.

### BRIEF DESCRIPTION OF THE DRAWINGS

FIG. 1 is a perspective view schematically showing a coil electronic component according to an embodiment.

FIG. 2 is a schematic top plan view of the coil electronic component illustrated in FIG. 1.

FIG. 3 is a schematic side perspective view of the coil electronic component illustrated in FIG. 1.

FIG. 4 is a schematic perspective view showing the frame of the coil electronic component illustrated in FIG. 1.

FIG. 5 is a schematic perspective view showing an example of a conductive layer disposed in the frame illustrated in FIG. 4.

FIG. 6 is a perspective view showing the connection structure of the coil and the frame of the coil electronic component illustrated in FIG. 1.

FIG. 7 is a schematic cross-sectional view showing the connection structure of the lead-out terminal and the frame of the coil electronic component illustrated in FIG. 1.

FIG. 8 is a schematic cross-sectional view taken along line I-I′ in FIG. 6.

FIG. 9 is a schematic exploded perspective view showing an example of the coil and frame of the coil electronic component illustrated in FIG. 1 being disposed in a magnetic body.

FIG. 10 is a schematic perspective view showing the coil and the frame illustrated in FIG. 9 disposed in a magnetic body.

FIG. 11 is a top plan view schematically showing the coil electronic component according to Comparative Example.

FIG. 12 is a schematic side perspective view of the coil electronic component illustrated in FIG. 11.

FIG. 13 is a perspective view schematically showing the coil electronic component according to another Comparative Example.

FIG. 14 is a partial side perspective view of the coil electronic component illustrated in FIG. 13.

FIG. 15 is a schematic cross-sectional view showing the connection structure of the lead-out terminal and the frame of the coil electronic component according to another embodiment.

FIG. 16 is a schematic perspective view showing a modification example of the frame illustrated in FIG. 4.

FIG. 17 is a schematic perspective view showing the conductive layer placed on the frame illustrated in FIG. 16.

FIG. 18 is a schematic perspective view showing the coil connected to the frame illustrated in FIG. 16.

FIG. 19 is a schematic perspective view showing another modification example of the frame illustrated in FIG. 4.

FIG. 20 is a side view of the frame illustrated in FIG. 19.

FIG. 21 is a schematic perspective view showing the coil connected to the frame illustrated in FIG. 19.

FIG. 22 is a schematic cross-sectional view taken along line II-II′ in FIG. 21.

FIG. 23 is a top plan view schematically showing the coil electronic component according to another embodiment.

FIG. 24 is a schematic side perspective view of the coil electronic component illustrated in FIG. 23.

FIG. 25 is a schematic perspective view showing the frame of the coil electronic component illustrated in FIG. 23.

### DETAILED DESCRIPTION

Hereinafter, various embodiments of the present disclosure will be described in detail so that a person of ordinary skill in the technical field to which the present disclosure belongs can easily implement it with reference to the accompanying drawings. The drawings and description are to be regarded as illustrative in nature and not restrictive. Like reference numerals designate like elements throughout the specification. In addition, some components in the accompanying drawings are exaggerated, omitted, or schematically illustrated, and the size of each component does not fully reflect the actual size.

The attached drawings are only intended to facilitate understanding of the embodiments disclosed in this specification, and the technical ideas disclosed in this specification are not limited by the attached drawings, and should be understood to include all modifications, equivalents, or substitutes included in the spirit and technical scope of the present disclosure.

Terms that include ordinal numbers, such as first, second, etc., may be used to describe various configurations of elements, but the components are not limited by the terms. The terms are used solely to distinguish one component from another.

Furthermore, it will be understood that when an element such as a layer, film, region, or substrate is referred to as being “on” another element, it can be directly on the other element or intervening elements may also be present. In contrast, when an element is referred to as being “directly on” another element, there are no intervening elements present. Also, being “above” or “on” the referenced part means being positioned above or below the referenced part, and does not necessarily mean being positioned “above” or “on” the opposite direction of gravity.

Throughout the specification, the terms “includes” or “has” should be understood to specify the presence of a feature, number, step, operation, component, part, or combination thereof described in the specification, but not to exclude the possibility of the presence or addition of one or more other features, numbers, steps, operations, components, parts, or combinations thereof. Therefore, when a part is said to “include” a component, this does not mean that it excludes other components, unless otherwise specifically stated, but rather that it may include other components.

Additionally, throughout the specification, the term “in plan” means that the target portion is viewed from above, and the term “in cross-section” means that the target portion is viewed from the side in a cross-section cut vertically.

Also, throughout the specification, the term “connected” does not only mean that two or more components are directly connected, but also that two or more components are indirectly connected through other components, that they are electrically connected as well as physically connected, or that they are referred to by different names depending on position or function but are one.

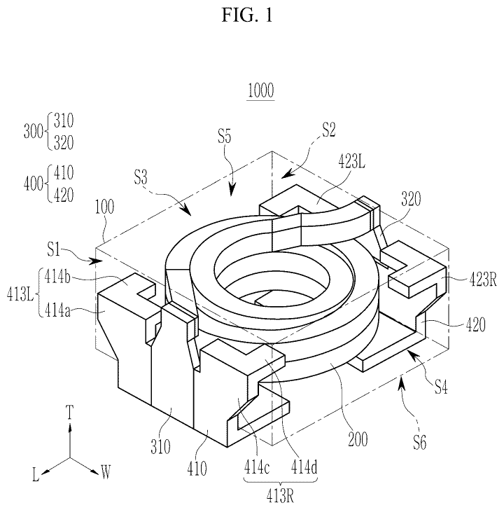

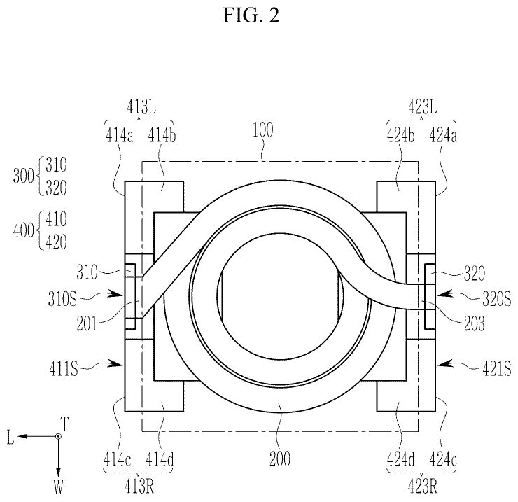

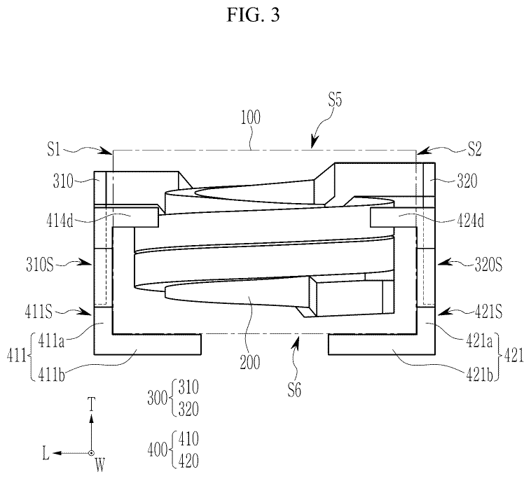

FIG. 1 is a perspective view schematically showing the coil electronic components according to an embodiment, FIG. 2 is a schematic top plan view of the coil electronic component illustrated in FIG. 1, and FIG. 3 is a schematic side perspective view of the coil electronic component illustrated in FIG. 1.

Referring to FIG. 1, FIG. 2, and to FIG. 3, a coil electronic component 1000 according to an embodiment includes a magnetic body 100, a coil 200, a lead-out terminal 300, and a frame 400.

The magnetic body 100 may have a substantially rectangular hexahedral shape, but the present embodiment is not limited thereto. Due to shrinkage of magnetic powder, etc. during sintering, the magnetic body 100 may not have a perfect rectangular hexahedral shape, but may have a substantially rectangular hexahedral shape. For example, the magnetic body 100 has a substantially rectangular parallelepiped shape, but portions corresponding to corners or vertices may each have a rounded shape.

In the present embodiment, for better understanding and ease of explanation, two surfaces opposing each other in the length direction (L-axis direction) of the magnetic body 100 are defined as a first surface S1 and a second surface S2, respectively, two surfaces opposing each other in the width direction (W-axis direction) of the magnetic body 100 are defined as a third surface S3 and a fourth surface S4, respectively, and two surfaces opposing each other in the thickness direction (T-axis direction) of the magnetic body 100 are defined as a fifth surface S5 and a sixth surface S6, respectively.

A length of the coil electronic component 1000 may refer to, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value among lengths of a plurality of line segments that connect two outermost boundary lines opposing each other in the length direction (L-axis direction) of the coil electronic component 1000 shown in the cross-sectional photograph described above and are parallel to the length direction (L-axis direction). Alternatively, the length of the coil electronic component 1000 may refer to a minimum value among lengths of a plurality of line segments that connect two outermost boundary lines opposing each other in the length direction (L-axis direction) of the coil electronic component 1000 shown in the cross-sectional photograph described above and are parallel to the length direction (L-axis direction). Alternatively, the length of the coil electronic component 1000 may indicate an arithmetic average value of the lengths of at least two line segments among a plurality of line segments that connect two outermost boundary lines opposing each other in the length direction (L-axis direction) of the coil electronic component 1000 shown in the cross-sectional photograph described above and are parallel to the length direction (L-axis direction).

A thickness of the coil electronic component 1000 may refer to, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value among lengths of a plurality of line segments that connect two outermost boundary lines opposing each other in the thickness direction (T-axis direction) of the coil electronic component 1000 shown in the cross-sectional photograph described above and are parallel to the thickness direction (T-axis direction). Alternatively, the thickness of the coil electronic component 1000 may refer to a minimum value among lengths of a plurality of line segments that connect two outermost boundary lines opposing each other in the thickness direction (T-axis direction) of the coil electronic component 1000 illustrated in the cross-sectional photograph described above and are parallel to the thickness direction (T-axis direction). Alternatively, the thickness of the coil electronic component 1000 may refer to an arithmetic average value of the lengths of at least two line segments among a plurality of line segments that connect two outermost boundary lines opposing each other in the thickness direction (T-axis direction) of the coil electronic component 1000 illustrated in the cross-sectional photograph described above and are parallel to the thickness direction (T-axis direction).

A width of the coil electronic component 1000 may refer to, based on an optical microscope or scanning electron microscope (SEM) photograph of a cross-section taken along the length direction (L-axis direction)-width direction (W-axis direction) at a center of the coil electronic component 1000 in the thickness direction (T-axis direction), a maximum value among lengths of a plurality of line segments that connect two outermost boundary lines opposing each other in the width direction (W-axis direction) of the coil electronic component 1000 shown in the cross-sectional photograph described above and are parallel to the width direction (W-axis direction). Alternatively, the width of the coil electronic component 1000 may refer to a minimum value among lengths of a plurality of line segments that connect two outermost boundary lines opposing each other in the width direction (W-axis direction) of the coil electronic component 1000 shown in the cross-sectional photograph described above and are parallel to the width direction (W-axis direction). Alternatively, the width of the coil electronic component 1000 may refer to an arithmetic average value of the lengths of at least two line segments among a plurality of line segments that connect two outermost boundary lines opposing each other in the width direction (W-axis direction) of the coil electronic component 1000 shown in the cross-sectional photograph described above and are parallel to the width direction (W-axis direction).

Each of the length, width, and thickness of the coil electronic component 1000 may be measured by a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and thickness of the coil electronic component 1000.

The magnetic body 100 constitutes an exterior of the coil electronic component 1000, and is a space where a magnetic path, which is a path through which the magnetic flux generated by the coil 200 passes, is formed, when a current is applied to the coil 200 through the frame 400.

The magnetic body 100 may surround and encapsulate the coil 200 and may include a magnetic material. The magnetic body 100 may include magnetic particles, and an insulating material may be interposed between the magnetic particles.

The magnetic material may include a first metal magnetic particle, a second metal magnetic particle having a smaller particle size than that of the first metal magnetic particle, and a third metal magnetic particle having a smaller particle size than that of the second metal magnetic particle. An average particle diameter (D₅₀) of the first metal magnetic particle may be 5 μm or more and 30 μm or less, an average particle diameter (D₅₀) of the second metal magnetic particle may be 1 μm or more and 5 μm or less, and an average particle diameter (D₅₀) of the third metal magnetic particle may be 0.05 μm or more and 0.5 μm or less.

The magnetic particle may be ferrite particles or metal magnetic particles exhibiting magnetic characteristics.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet—type ferrites such as Y-based ferrites and Li-based ferrite.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particles may be amorphous or crystalline. For example, the metal magnetic particles may be an Fe—Si—B—Cr amorphous alloy, but the present embodiment is not limited thereto. The metal magnetic particles may have an average particle diameter in a range from about 0.1 μm to 30 μm, but the embodiment is not limited thereto. In the specification, the average particle size may mean a particle size distribution expressed by D₉₀, D₅₀, or the like. The particle size distribution is well known to those skilled in the art as an index indicating what size (particle diameter) particles are included in what proportion in a particle group to be measured. D₅₀ (a particle diameter corresponding to 50 % of a cumulative volume of the particle size distribution) refers to an average particle diameter.

The metal magnetic particles may be two or more types of different metal magnetic particles. Herein, by different types of metal magnetic particles, it is meant that the metal magnetic particles are distinguished from each other in at least one of an average particle diameter, composition, component ratio, crystallinity, and shape.

The insulating material may include epoxy, polyimide, liquid crystal crystalline polymer, etc., alone or in combination, but the embodiment is not limited thereto.

The method of forming the magnetic body 100 is not particularly limited. For example, sheets made of magnetic material may be disposed at an upper portion and a lower portion of the coil 200, and then pressed and cured to form the magnetic body 100.

The coil 200 may be embedded in the magnetic body 100 to exhibit the characteristics of the coil electronic component 1000. For example, when the coil electronic component 1000 of the present embodiment is used as a power inductor, when a current is applied to the coil 200, the coil 200 may serve to stabilize the power supply of an electronic device by storing energy in the form of a magnetic field to maintain an output voltage.

The coil 200 may include at least one turn of a conductive wire. For example, the coil 200 may have a shape in which a metal (e.g., copper (Cu) or silver (Ag)) wire coated with an insulating material is spirally wound. The coil 200 is not limited to a single wire, but may comprise a stranded wire or two or more wires.

When viewed in the thickness direction (T-axis direction), the coil 200 may be circular, but is not limited thereto. For example, when viewed in the thickness direction (T-axis direction), the coil 200 may have various known shapes such as a rectangle.

The cross-section intersecting the extending direction of the individual conductive wires of the coil 200 may have various known shapes such as quadrangle, circle, ellipse, etc.

The lead-out terminal 300 connects the coil 200 and the frame 400.

The lead-out terminal 300 may have a plate shape. For example, a cross-section along the length direction (L-axis direction)-thickness direction (T-axis direction) of the lead-out terminal 300 may have an approximately rectangular shape. However, the present embodiment is not limited thereto.

The lead-out terminal 300 may be made of the same or different material as the coil 200. For example, the lead-out terminal 300 may include copper (Cu), but the present embodiment is not limited thereto.

For example, the lead-out terminal 300 may be formed by rolling an end of the coil 200. Here, the lead-out terminal 300 is made of the same material as the coil 200.

In another example, the lead-out terminal 300 may be manufactured separately from the coil 200 and joined to the coil 200. Here, the lead-out terminal 300 may be made of the same or different material as the coil 200.

The lead-out terminal 300 includes a first lead-out terminal 310 and a second lead-out terminal 320.

The first lead-out terminal 310 connects the first end 201 of the coil 200 and the first frame 410 (described later). The second lead-out terminal 320 connects the second end 203 of the coil 200 and the second frame 420 (described later).

The frame 400 includes a first frame 410 and a second frame 420. The frame 400 may include copper (Cu), tin (Sn) or an alloy thereof, but the present embodiment is not limited thereto.

The first frame 410 is connected to the first lead-out terminal 310, and the second frame 420 is connected to the second lead-out terminal 320.

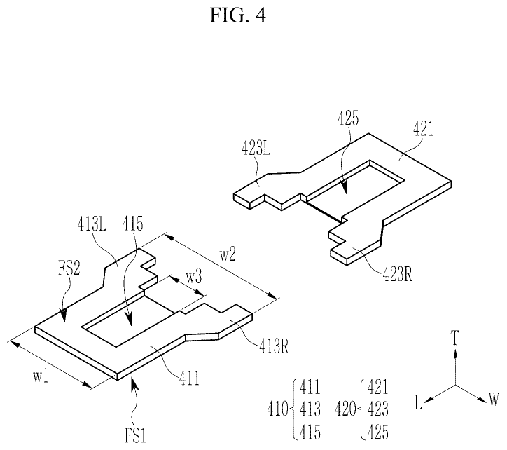

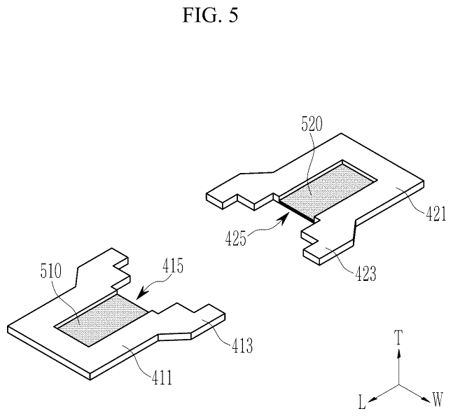

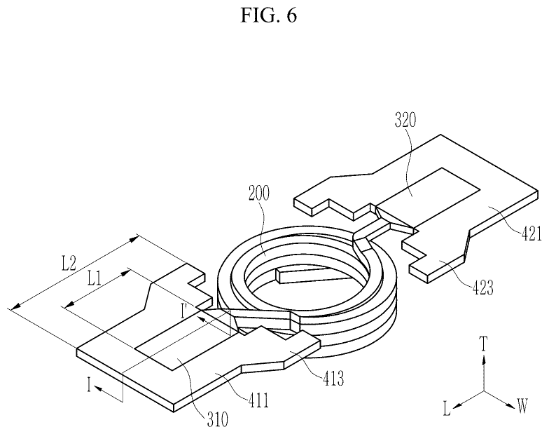

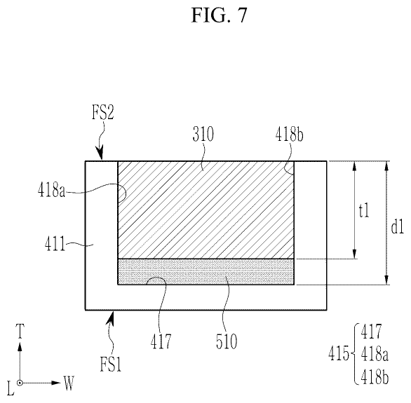

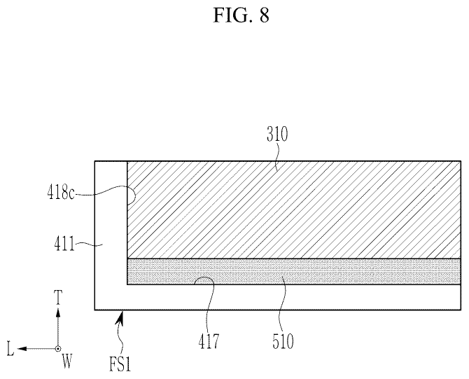

Hereinafter, referring to FIG. 4, FIG. 5, FIG. 6, FIG. 7, and FIG. 8, the structure of the frame and the connection structure of the frame and the lead-out terminal are described in detail.

FIG. 4 is a schematic perspective view showing the frame of the coil electronic component illustrated in FIG. 1, and FIG. 5 is a schematic perspective view showing an example of a conductive layer disposed in the frame illustrated in FIG. 4. FIG. 6 is a perspective view showing the connection structure of the coil and frame of the coil electronic component illustrated in FIG. 1, and FIG. 7 is a schematic cross-sectional view showing the connection structure of the lead-out terminal and frame of the coil electronic component illustrated in FIG. 1. FIG. 8 is a schematic cross-sectional view taken along line I-I′ in FIG. 6. For better understanding and ease of description, the above drawings show the frame in an unbent state.

Referring to FIG. 4, the first frame 410 has a generally plate-like shape and may include a first frame body 411, a first extension 413, and a first recess 415. Similarly, the second frame 420 has a generally plate-like shape and may include a second frame body 421, a second extension 423, and a second recess 425. The second frame 420 corresponds to first frame 410 except for its location, so the following description will focus on the first frame 410.

The first frame 410 may include a first main surface FS1 and a second main surface FS2 which are opposed to each other in the thickness direction (T-axis direction). The first recess 415 may have a shape formed by a depression in a portion of the second main surface FS2 of the first frame 410. One end of the first recess 415 in the length direction (L-axis direction) is open and the other end is closed.

The first frame body 411 constitutes the overall exterior of the first frame 410, and the first extension 413 is a portion that protrudes from the first frame body 411.

The first extension 413 may include a third extension 413L and a fourth extension 413R, each protruding from the first frame body 411. The third extension 413L and the fourth extension 413R may be opposed to each other in the width direction (W-axis direction).

The first frame 410 may have a first width w1 and a second width w2. The first width w1 may be the width of the portion of the first frame 410 without the first extension 413, i.e., the width of the first frame body 411. The second width w2 may be the width of the portion of the first frame 410 where the first extension 413 is disposed. For example, the minimum width of the first frame 410 may be the first width w1 and the maximum width may be the second width w2. Depending on the shape of the first extension 413, there may be a region where the width of the first frame 410 changes from the first width w1 to the second width w2. However, the present embodiment is not limited thereto.

The width w3 of the first recess 415 may be smaller than the first width w1 of the first frame 410. For example, the maximum width of the first recess 415 may be smaller than the width of the first frame body 411.

In another embodiment, the first frame 410 may not include the first extension 413. Here, the first frame 410 viewed from the thickness direction (T-axis direction) may have an approximately rectangular shape.

Referring to FIG. 5, a first conductive layer 510 is disposed within the first recess 415 and a second conductive layer 520 is disposed within the second recess 425. For example, silver (Ag) nanopaste may be applied to the first recess 415 and the second recess 425 to form the first conductive layer 510 and the second conductive layer 520. However, the present embodiment is not limited thereto.

Thereafter, as shown in FIG. 6, the first lead-out terminal 310 and the first frame 410 may be connected to each other by the first lead-out terminal 310 being received within the first recess 415. For example, when the first lead-out terminal 310 is disposed within the first recess 415, the first lead-out terminal 310 comes into contact with the silver (Ag) nanopaste. As a result, the first lead-out terminal 310 and the first frame 410 are connected via the first conductive layer 510. Afterwards, the silver (Ag) nanoparticles are sintered by a curing process at a temperature in a range of 150° C. to 200° C. Accordingly, the first lead-out terminal 310 and the first frame 410 are bonded to each other. Similarly, the second lead-out terminal 320 and the second frame 420 may be bonded to each other.

Here, the length L1 of the first lead-out terminal 310 may be greater than or equal to 50% and less than or equal to 70% of the length L2 of the first frame 410. If the first lead-out terminal 310 is less than 50% of the length of the first frame 410, the bonding strength of the first lead-out terminal 310 and the first frame 410 may not be sufficient and may be vulnerable to external vibration.

Referring to FIG. 7 and FIG. 8, the first recess 415 may include a bottom surface 417 (e.g., first surface), a first interior surface 418a, a second interior surface 418b, and a third interior surface 418c, and a first conductive layer 510 may be disposed between the first recess 415 and the first lead-out terminal 310.

The first conductive layer 510 may be disposed between the first lead-out terminal 310 and the bottom surface 417. Here, the first lead-out terminal 310 may be in direct contact with the first interior surface 418a, the second interior surface 418b, and the third interior surface 418c of the first recess 415, respectively, but may not be in direct contact with the bottom surface 417.

In another embodiment, the first conductive layer 510 may be disposed between the third interior surface 418c of the first recess 415 and the first lead-out terminal 310. Here, the first lead-out terminal 310 may not be in direct contact with the third interior surface 418c.

The first conductive layer 510 may include silver (Ag), copper (Cu), annealed copper, gold (Au), aluminum (Al), calcium (Ca), tungsten (W), zinc (Zn), nickel (Ni), lithium (Li), iron (Fe), platinum (Pt), tin (Sn), or an alloy thereof. However, the present embodiment is not limited thereto.

The first conductive layer 510 may include an intermetallic compound. For example, the first conductive layer 510 may include Cu₆Sn₅ and/or Cu₃Sn.

Meanwhile, the first conductive layer 510 may include metal nanoparticles. The type of metal nanoparticle is not particularly limited, and may include nanoparticles such as gold (Au), silver (Ag), copper (Cu), platinum (Pt), ruthenium (Ru), rhodium (Rh), palladium (Pd), osmium (Os), and iridium (Ir).

Here, the thickness t1 of the first lead-out terminal 310 may be smaller than the depth d1 of the first recess 415. Here, the first lead-out terminal 310 does not protrude further than the second main surface FS2 of the first frame 410 in the thickness direction (T-axis direction).

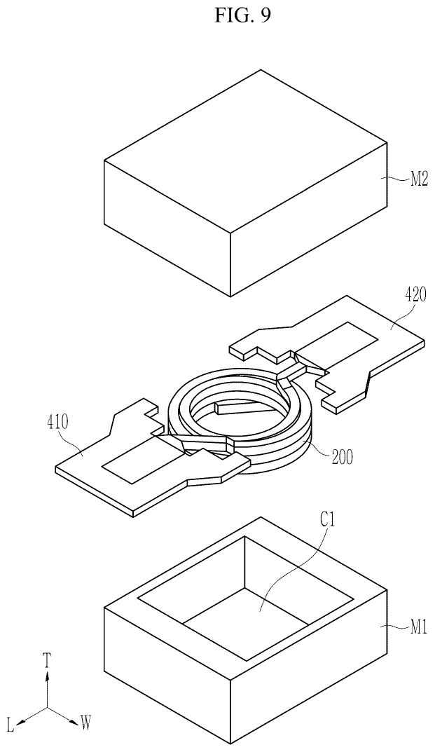

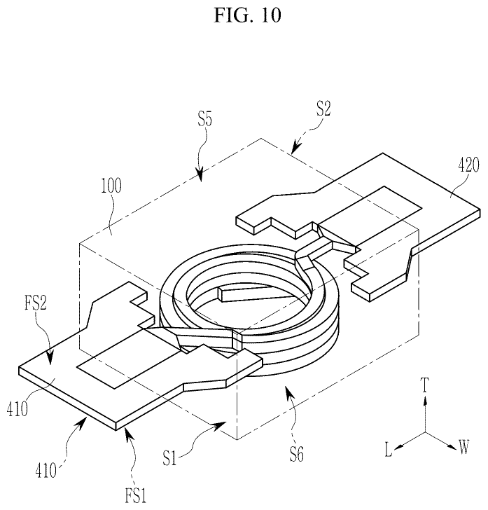

Hereinafter, referring to FIG. 9 and FIG. 10, a method for manufacturing a coil electronic component is briefly described.

FIG. 9 is a schematic exploded perspective view showing an example of the coil and frame of the coil electronic component illustrated in FIG. 1 being disposed in a magnetic body, and FIG. 10 is a schematic perspective view showing the coil and the frame illustrated in FIG. 9 disposed in a magnetic body.

Referring to FIG. 9, the coil 200 connected to the first frame 410 and the second frame 420 may be disposed between a lower magnetic sheet M1 and an upper magnetic sheet M2, and then the lower magnetic sheet M1 and the upper magnetic sheet M2 may be pressed together. For example, after placing the coil 200 in the internal space C1 of the lower magnetic sheet M1, pressure may be applied to the lower magnetic sheet M1 and the upper magnetic sheet M2 and a curing process may be performed.

Accordingly, a magnetic body 100 with a coil 200 embedded therein may be formed, as shown in FIG. 10. A portion of the first frame 410 and a portion of the second frame 420 are exposed to the outside of the magnetic body 100. Here, the exposed portion of the first frame 410 is bent twice so that the portion contacts the first surface S1 and the sixth surface S6 of the magnetic body 100. Similarly, the exposed portion of the second frame 420 is bent twice so that the portion contacts the second surface S2 and the sixth surface S6 of the magnetic body 100. Accordingly, a coil electronic component may be manufactured, such as the one shown in FIG. 1. For example, the first main surface FS1 of the first frame 410 may contact the first surface S1 and the sixth surface S6 of the magnetic body 100, and the second main surface FS2 may not contact the magnetic body 100.

Referring back to FIG. 1, FIG. 2, and FIG. 3, the first frame body 411 may be disposed outside the magnetic body 100.

Referring to FIG. 3, the first frame body 411 may include a third frame body 411a and a fourth frame body 411b. The third frame body 411a is a portion disposed on the first surface S1 of the magnetic body 100, and the fourth frame body 411b is a portion disposed on the sixth surface S6 of the magnetic body 100. The fourth frame body 411b may have a bent shape relative to the third frame body 411a. For example, the third frame body 411a may contact the first surface S1 of the magnetic body 100, and the fourth frame body 411b may contact the sixth surface S6 of the magnetic body 100. However, the present embodiment is not limited thereto.

The first lead-out terminal 310 may be accommodated in the first recess 415 (see FIG. 4) of the first frame body 411. For example, the first recess 415 (see FIG. 4) may be formed in the third frame body 411a. Referring to FIG. 2 and FIG. 3, an outer surface 310S of the first lead-out terminal 310 may not protrude from an outer surface 411S of the third frame body 411a in the length direction (L-axis direction). That is, the outer surface 310S of the first lead-out terminal 310 and the outer surface 411S of the third frame body 411a may be flush with each other.

The first extension 413 may include a third extension 413L and a fourth extension 413R, each protruding from the first frame body 411.

Referring to FIG. 2, the third extension 413L may include an outer portion 414a and an inner portion 414b. The outer portion 414a is a portion disposed outside the magnetic body 100, and the inner portion 414b is a portion disposed inside the magnetic body 100. The outer portion 414a may have a bent shape relative to the inner portion 414b. For example, the outer portion 414a may be parallel to the first surface S1 of the magnetic body 100, and the inner portion 414b may be parallel to the fifth surface S5 of the magnetic body 100. However, the present embodiment is not limited thereto.

The fourth extension 413R opposes the third extension 413L in the width direction (W-axis direction). The fourth extension 413R may include an outer portion 414c and an inner portion 414b. The fourth extension 413R corresponds to the third extension 413L except for its location, so a repeated description thereof will be omitted.

The second frame body 421 may be disposed outside the magnetic body 100.

Referring to FIG. 3, the second frame body 421 may include a fifth frame body 421a and a sixth frame body 421b. The fifth frame body 421a is a portion disposed on the first surface S1 of the magnetic body 100, and the sixth frame body 421b is a portion disposed on the sixth surface S6 of the magnetic body 100. The sixth frame body 421b may have a bent shape relative to the fifth frame body 421a. For example, the fifth frame body 421a may contact the first surface S1 of the magnetic body 100, and the sixth frame body 421b may contact the sixth surface S6 of the magnetic body 100. However, the present embodiment is not limited thereto.

The second lead-out terminal 320 may be accommodated in the second recess 425 (see FIG. 4) of the second frame body 421. For example, referring to FIG. 2 and FIG. 3, an outer surface 320S of the second lead-out terminal 320 may not protrude from an outer surface 421S of the fifth frame body 421a in the length direction (L-axis direction). That is, the outer surface 320S of the second lead-out terminal 320 and the outer surface 421S of the fifth frame body 421a may be flush with each other.

The second extension 423 may include a fifth extension 423L and a sixth extension 423R, each protruding from the second frame body 421.

Referring to FIG. 2, the fifth extension 423L may include an outer portion 424a and an inner portion 424b. The outer portion 424a is a portion disposed outside the magnetic body 100, and the inner portion 424b is a portion disposed inside the magnetic body 100. The outer portion 424a may have a bent shape relative to the inner portion 424b. For example, the outer portion 424a may be parallel to the second surface S2 of the magnetic body 100, and the inner portion 424b may be parallel to the fifth surface S5 of the magnetic body 100. However, the present embodiment is not limited thereto.

The sixth extension 423R opposes the fifth extension 423L in the width direction (W-axis direction). The sixth extension 423R may include an outer portion 424c and an inner portion 424b. The sixth extension 423R corresponds to the third extension 413L except for its location, so a repeated description thereof will be omitted.

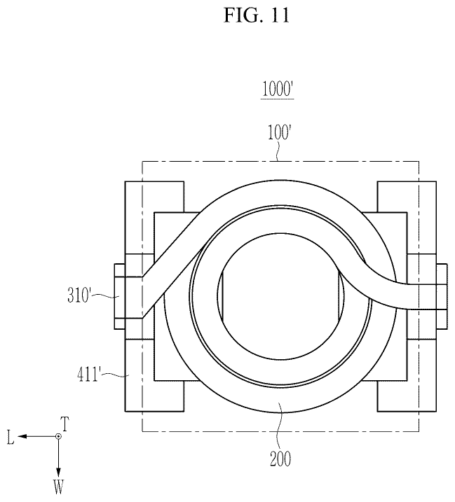

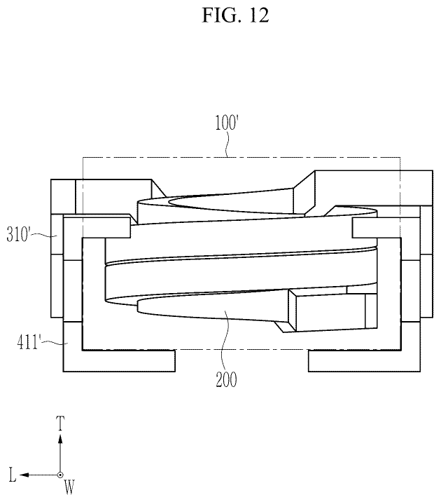

FIG. 11 is a top plan view schematically showing the coil electronic components according to Comparative Example, and FIG. 12 is a schematic side perspective view of the coil electronic component illustrated in FIG. 11.

Referring to FIG. 11 and FIG. 12, the first lead-out terminal 310′of the coil electronic component 1000′ is disposed to protrude from the first frame body 411′ in the length direction (L-axis direction). As the first lead-out terminal 310′ protrudes, the size of the magnetic body 100′ may be relatively reduced, and the electromagnetic characteristics of the coil electronic component 1000′may be reduced.

On the other hand, according to the present embodiment, since the first lead-out terminal 310 does not protrude from the first frame body 411 in the length direction (L-axis direction), the size of the magnetic body 100 may be relatively increased, and the electromagnetic characteristics of the coil electronic component 1000 may be improved accordingly.

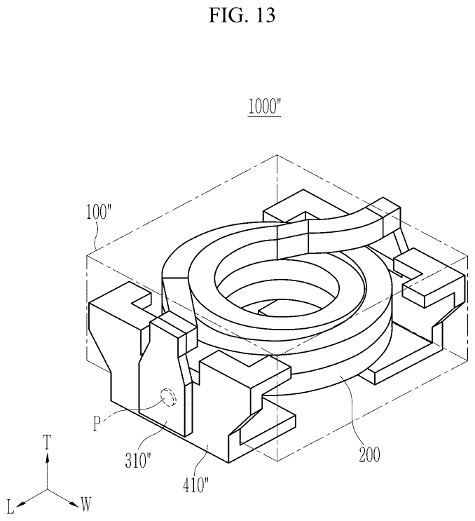

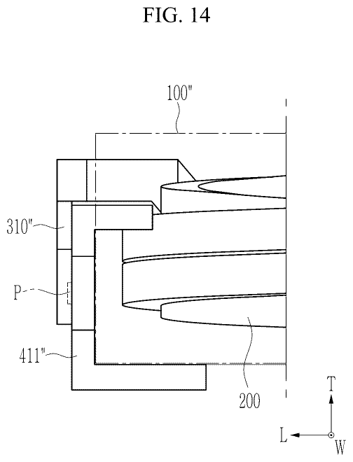

FIG. 13 is a perspective view schematically showing the coil electronic components according to another Comparative Example, and FIG. 14 is a partial side perspective view of the coil electronic component illustrated in FIG. 13.

Referring to FIG. 13 and FIG. 14, the first lead-out terminal 310″ of the coil electronic component 1000″ is joined to the first frame 410″ by welding. That is, the first lead-out terminal 310″ and the first frame 410″ are point welded, and a point joint P is formed between the first lead-out terminal 310″ and the first frame 410″.

The point joint P serves as a via connecting the first lead-out terminal 310″ and the first frame 410″. Since the point joint P has a smaller cross-sectional area than the conductive wire of the coil 200, current may not flow as smoothly through the point joint P as it would flow through the conductive wire of the coil. As a result, the direct current resistance (Rdc) may increase. If the cross-sectional area of the first lead-out terminal 310″ is smaller than the cross-sectional area of the conductive wire of the coil 200, the direct current resistance (Rdc) may increase. Furthermore, since the size of the point joint P is small compared to the size of the portion where the first lead-out terminal 310″ and the first frame 410″ face each other, stresses may be concentrated at the point joint P in the event that continuous vibration is transmitted from the outside, causing the point joint P to break.

In contrast, according to the present embodiment, since the first lead-out terminal 310 is accommodated in the first recess 415 of the first frame 410, the first lead-out terminal 310 and the first frame 410 are face-to-face bonded by the first conductive layer 510. Here, since current flows through the entire contact surface of the first lead-out terminal 310 and the first frame 410, direct current resistance (Rdc) may be reduced even if the cross-sectional area of the first lead-out terminal 310 is smaller than the cross-sectional area of the conductive wire of the coil 200. Furthermore, since face-to-face bonds are stronger than point joints, they are less likely to be broken by externally transmitted vibrations.

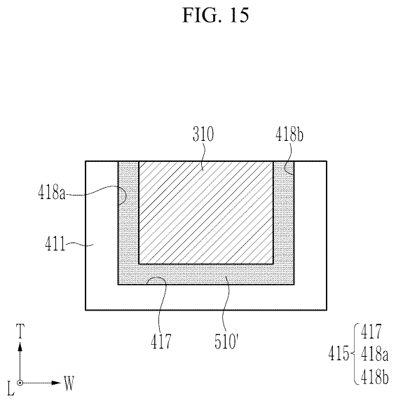

FIG. 15 is a schematic cross-sectional view showing the connection structure of the lead-out terminal and the frame of the coil electronic component according to another embodiment.

Referring to FIG. 15, the first conductive layer 510′can be in direct contact with at least three surfaces of the first recess 415 of the first frame 410. The first conductive layer 510′ may be disposed between the first lead-out terminal 310 and the bottom surface 417, between the first lead-out terminal 310 and the first interior surface 418a, and between the first lead-out terminal 310 and the second interior surface 418b, respectively.

The remaining components are identical to the components of the coil electronic component shown in FIG. 1, so a repeated description thereof will be omitted.

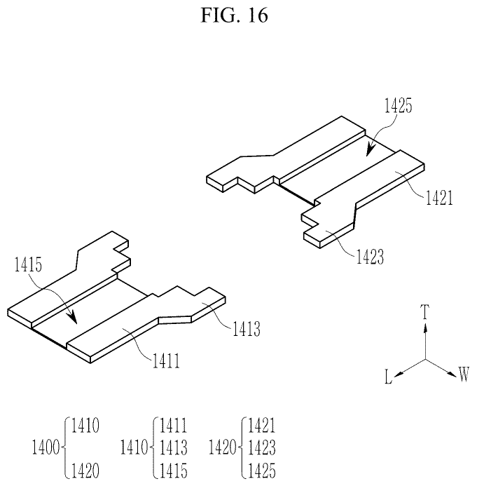

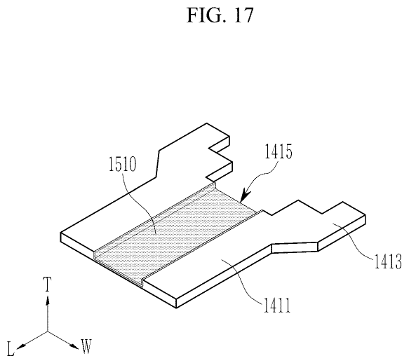

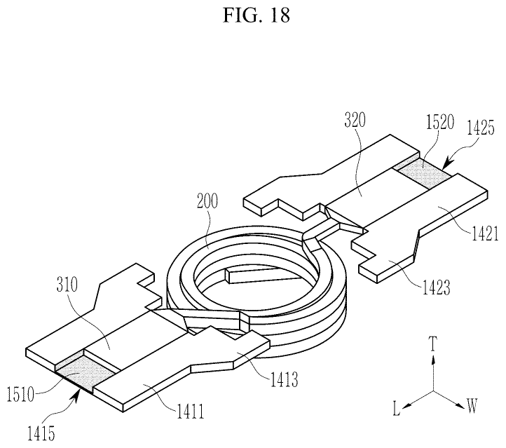

FIG. 16 is a schematic perspective view showing a modification example of the frame illustrated in FIG. 4, FIG. 17 is a schematic perspective view showing the conductive layer placed on the frame illustrated in FIG. 16, and FIG. 18 is a schematic perspective view showing the coil connected to the frame illustrated in FIG. 16.

Referring to FIG. 16, the frame 1400 includes a first frame 1410 and a second frame 1420.

The first frame 1410 may include a first frame body 1411, a first extension 1413, and a first recess 1415. The second frame 1420 may include a second frame body 1421, a second extension 1423, and a second recess 1425. Since the second frame 1420 corresponds to the first frame 1410 except for its location, the following description will only describe the first frame 1410 and the description of the second frame 1420 will be omitted.

The first recess 1415 may have a shape formed by a depression in a portion of the surface in the thickness direction (T-axis direction) of the first frame body 1411. Both ends of the first recess 1415 in the length direction (L-axis direction) are open.

Referring to FIG. 17, a first conductive layer 1510 is disposed in the first recess 1415. For example, silver (Ag) nanopaste may be applied to the first recess 1415 to form the first conductive layer 1510. However, the present embodiment is not limited thereto.

Since both ends in the length direction (L-axis direction) of the first recess 1415 are open, the first recess 1415 may be larger than the first recess 415 of FIG. 4 if the first frame 1410 and the first frame 410 shown in FIG. 4 have the same size. Therefore, the first conductive layer 1510 formed in the first recess 1415 may be larger than the first conductive layer 510 of FIG. 5 and may also have stronger bonding strength.

Thereafter, as shown in FIG. 18, the first lead-out terminal 310 and the first frame 1410 may be connected to each other by the first lead-out terminal 310 being received within the first recess 1415. Similarly, the second lead-out terminal 320 and the second frame 1420 may be connected to each other by the second lead-out terminal 320 being received within the second recess 1425.

Here, both ends in the length direction (L-axis direction) of the first recess 1415 are open, so that a portion of the first conductive layer 1510 may be exposed without contacting the first lead-out terminal 310. A portion of the second conductive layer 1520 may also be exposed without contacting the second lead-out terminal 320. However, the present embodiment is not limited thereto.

The remaining components are identical or correspond to the frame of FIG. 4, so a repeated description thereof will be omitted.

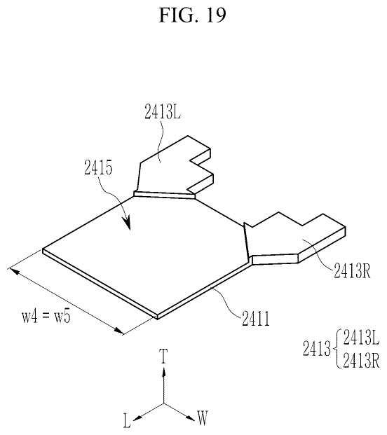

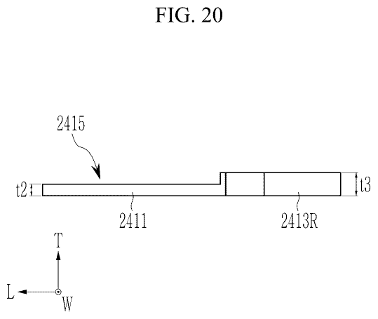

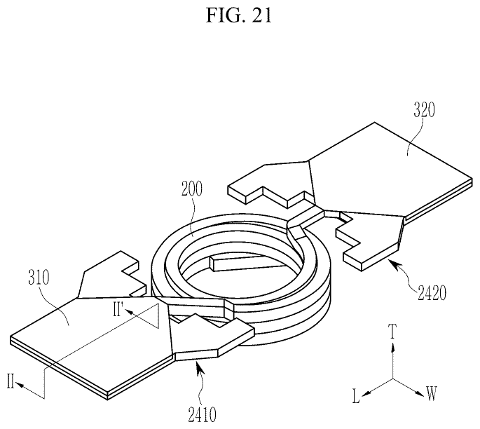

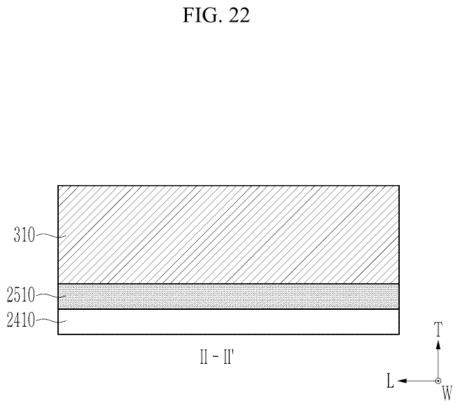

FIG. 19 is a schematic perspective view showing another modification example of the frame illustrated in FIG. 4, FIG. 20 is a side view of the frame illustrated in FIG. 19, FIG. 21 is a schematic perspective view showing the coil connected to the frame illustrated in FIG. 19, and FIG. 22 is a schematic cross-sectional view taken along line II-II′ in FIG. 21.

Referring to FIG. 19, a first frame 2410 may include a first frame body 2411, a first extension 2413, and a first recess 2415. Since the second frame 2420 corresponds to the first frame 2410 except for its location, the following discussion will focus on the first frame 2410.

The first extension 2413 may include a third extension 2413L and a fourth extension 2413R, each protruding from the first frame body 2411.

The first recess 2415 may have a shape formed by depression in a portion of the surface in the thickness direction (T-axis direction) of the first frame body 2411. The first recess 2415 is open except for the portion where it contacts the first extension 2413. That is, one end in the length direction (L-axis direction) of the first recess 2415 is open and a portion of the other end is open. A portion of one end in the width direction (W-axis direction) of the first recess 2415 and a portion of the other end are open.

In the region between the third extension 2413L and the fourth extension 2413R, the first recess 2415 may have a shape that decreases in width, and in the remaining region, the first recess 2415 may have a width of a constant size. For example, the maximum width w4 of the first recess 2415 may be equal to the width w5 of the frame body 2411. However, the present embodiment is not limited thereto.

Referring to FIG. 20, in the region where the first recess 2415 is formed, the thickness t2 of the first frame body 2411 may be smaller than the thickness t3 of the first extension 2413.

Referring to FIG. 21, the first lead-out terminal 310 is disposed in the first recess 2415, so that the first lead-out terminal 310 and the first frame 2410 may be connected to each other. In the same way, the second lead-out terminal 320 and the second frame 2420 may be connected to each other.

For example, referring to FIG. 22, the first lead-out terminal 310 may be disposed in the first recess 2415 and then rolled to form a clad metal structure in which the first lead-out terminal 310 and the first frame 2410 are bonded together. In particular, if the first lead-out terminal 310 and the first frame 2410 include different types of metal, an intermetallic compound layer 2510 may form at the interface of the first lead-out terminal 310 and the first recess 2415. The resultant intermetallic compound layer may serve as a conductive layer.

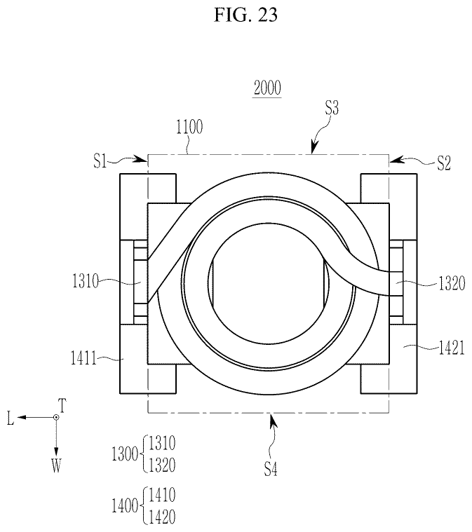

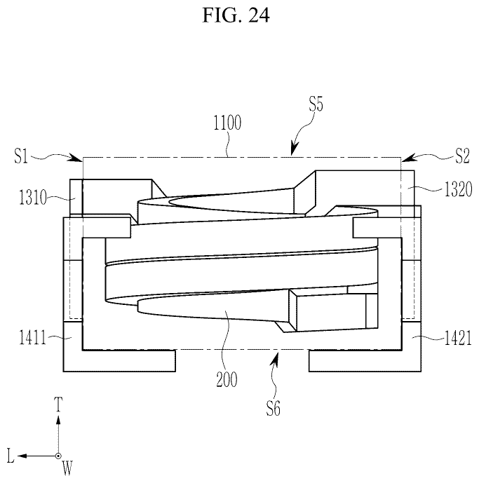

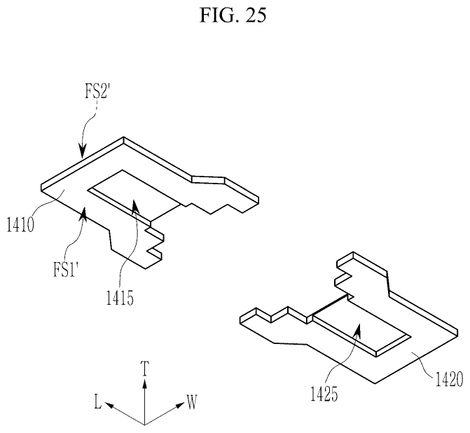

FIG. 23 is a top plan view schematically showing the coil electronic component according to another embodiment, FIG. 24 is a schematic side perspective view of the coil electronic component illustrated in FIG. 23, and FIG. 25 is a schematic perspective view showing the frame of the coil electronic component illustrated in FIG. 23.

Referring to FIG. 23 and FIG. 24, the first lead-out terminal 1310 of the coil electronic component 2000 may be disposed between the first frame body 1411 and the magnetic body 1100. For example, the first lead-out terminal 1310 may contact the first surface S1 of the magnetic body 1100, and the first frame body 1411 may contact the first lead-out terminal 1310 while also contacting the first surface S1 of the magnetic body 1100. Here, the first lead-out terminal 1310 may be accommodated in the first recess 1415 of the first frame body 1411. For example, referring to FIG. 25, the first frame 1410 may include a first main surface FS1′ and a second main surface FS2′. The first recess 1415 may have a shape formed by depression in a portion of the first main surface FS1′ of the first frame body 1411. The first recess 1415 may accommodate the first lead-out terminal 1310. For example, the structure of the first frame 1410, except for the location of the first recess 1415, may be identical to the structure of the first frame 410 of FIG. 4. Therefore, referring to FIG. 24 and FIG. 25 together, the first main surface FS1′ of the first frame 1410 may contact the first surface S1 and the sixth surface S6 of the magnetic body 1100, and the second main surface FS2′ may not contact the magnetic body 1100.

The remaining components are identical or correspond to the components of the coil electronic component shown in FIG. 1, so a repeated description thereof will be omitted.

The widths, thicknesses, lengths, and depths disclosed herein may be measured by an optical microscope or a scanning electron microscope (SEM). Other methods and/or tools appreciated by one of ordinary skill in the art, even if not described in the present disclosure, may also be used.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A coil electronic component comprising:
a magnetic body including a magnetic material,
a coil embedded in the magnetic body and including least one turn of a conductive wire,
a lead-out terminal connected to the coil,
a frame including a recess in which the lead-out terminal is received, and
a conductive layer disposed between the lead-out terminal and the recess.

2. The coil electronic component of claim 1, wherein
the recess includes a first surface, a first interior surface, and a second interior surface, and
the lead-out terminal contacts the first interior surface and the second interior surface.

3. The coil electronic component of claim 2, wherein
the conductive layer is disposed between the lead-out terminal and the first surface.

4. The coil electronic component of claim 2, wherein
the recess further includes a third interior surface connecting the first interior surface and the second interior surface, and
the lead-out terminal contacts the third interior surface.

5. The coil electronic component of claim 1, wherein
the recess includes a first surface, a first interior surface, and a second interior surface, and
the conductive layer is disposed between the lead-out terminal and the first surface, between the lead-out terminal and the first interior surface, and between the lead-out terminal and the second interior surface.

6. The coil electronic component of claim 5, wherein
the recess further includes a third interior surface connecting the first interior surface and the second interior surface, and
the lead-out terminal contacts the third interior surface.

7. The coil electronic component of claim 1, wherein
the frame further includes a frame body and an extension protruding from the frame body.

8. The coil electronic component of claim 7, wherein
a maximum width of the recess is smaller than a width of the frame body.

9. The coil electronic component of claim 7, wherein
a thickness of the frame body is smaller than a thickness of the extension.

10. The coil electronic component of claim 7, wherein
a maximum width of the recess is the same as a width of the frame body.

11. The coil electronic component of claim 7, wherein
the frame body is disposed outside the magnetic body.

12. The coil electronic component of claim 11, wherein
the extension includes a first portion disposed outside the magnetic body and a second portion connected to the first portion and disposed inside the magnetic body.

13. The coil electronic component of claim 12, wherein
the second portion has a bent shape relative to the first portion.

14. The coil electronic component of claim 11, wherein
the frame body includes a first frame body including the recess and a second frame body connected to the first frame body.

15. The coil electronic component of claim 14, wherein
the second frame body has a bent shape relative to the first frame body.

16. The coil electronic component of claim 14, wherein
the first frame body is disposed on an end surface in a length direction of the magnetic body, and
the second frame body is disposed on a first surface of the magnetic body.

17. The coil electronic component of claim 14, wherein
the first frame body includes a first main surface proximate an end surface in a length direction of the magnetic body, and a second main surface opposite the first main surface, and
the recess is a depression in a portion of the second main surface.

18. The coil electronic component of claim 14, wherein
the first frame body includes a first main surface proximate an end surface in a length direction of the magnetic body, and a second main surface opposite the first main surface, and
the recess is a depression in a portion of the first main surface.

19. The coil electronic component of claim 1, wherein
the lead-out terminal has a length greater than or equal to 50% and less than or equal to 70% of a length of the frame.

20. The coil electronic component of claim 1, wherein
a thickness of the lead-out terminal is smaller than a depth of the recess.

21. The coil electronic component of claim 1, wherein
the lead-out terminal includes copper (Cu).

22. The coil electronic component of claim 1, wherein
the frame includes (i) copper (Cu), (ii) tin (Sn) or an alloy of any of (i)-(ii).

23. The coil electronic component of claim 1, wherein
the conductive layer includes (i) silver (Ag), (ii) copper (Cu), (iii) annealed copper, (iv) gold (Au), (v) aluminum (Al), (vi) calcium (Ca), (vii) tungsten (W), (viii) zinc (Zn), (ix) nickel (Ni), (x) lithium (Li), (xi) iron (Fe), (xii) platinum (Pt), (xiii) tin (Sn), or an alloy of any of (i)-(xiii).

24. The coil electronic component of claim 1, wherein
the conductive layer includes an intermetallic compound.

25. The coil electronic component of claim 24, wherein
the intermetallic compound includes Cu₆Sn₅ and/or Cu₃Sn.

26. The coil electronic component of claim 1, wherein
the conductive layer includes metal nanoparticles.

27. A coil electronic component comprising:
a magnetic body including a magnetic material,
a coil embedded in the magnetic body and including least one turn of a conductive wire,
a lead-out terminal connected to the coil,
a frame including a recess,
wherein the lead-out terminal is disposed in the recess, and
wherein the recess faces outward from the magnetic body.

28. The coil electronic component of claim 27, wherein a conductive layer is disposed between the lead-out terminal and the frame, and a thickness of the lead-out terminal is smaller than a depth of the recess.

29. The coil electronic component of claim 27, wherein
the conductive layer includes nanoparticles that include silver (Ag).

30. The coil electronic component of claim 27, wherein
the conductive layer includes an intermetallic compound.

31. A coil electronic component comprising:
a magnetic body including a magnetic material,
a coil embedded in the magnetic body and including least one turn of a conductive wire,
a lead-out terminal connected to the coil,
a frame including a recess, the recess including a first end through which the lead-out terminal is received,
wherein the first end of the recess and a second end of the recess oppose each other in a thickness direction of the coil electronic component.

32. The coil electronic component of claim 31, wherein a conductive layer is disposed between the lead-out terminal and the frame, and a thickness of the lead-out terminal is smaller than a depth of the recess.

33. The coil electronic component of claim 31, wherein
the conductive layer includes nanoparticles that include silver (Ag).

34. The coil electronic component of claim 31, wherein
the conductive layer includes an intermetallic compound.
